(19) United States
(12) Patent Application Publication
(10) Pub. No.: US 2014/0177198 A1
(43) Pub. Date: Jun. 26, 2014

(54) Light source module and keyboard having the same

(71) Applicant: POWER LENS TECHNOLOGY INC., HSINCHU COUNTY (TW)

(72) Inventors: Pei-Yuan Hung, Hsinchu County (TW); Wei-Hung Liao, Hsinchu County (TW); An-Chi Wei, Hsinchu County (TW); Jyh-Long Chern, Hsinchu County (TW)

(73) Assignee: POWER LENS TECHNOLOGY INC., HSINCHU COUNTY (TW)

(21) Appl. No.: 13/968,413

(22) Filed: Aug. 15, 2013

Related U.S. Application Data
(60) Provisional application No. 61/683,330, filed on Aug. 15, 2012.

(51) Int. Cl. F21V 8/00

(52) U.S. Cl. CPC G02B 6/0036; G02B 6/005; G02B 6/0093; G02B 6/0081
USPC 362/23.03; 362/619; 362/607

(57) ABSTRACT

A light source module includes a light guide plate, a reflective plate, and at least one light emitting component. The reflective plate is provided at one side of the light guide plate, and the light emitting component is adjacent to the light guide plate. The light guide plate has at least one surface having an array of plural transparent microstructures. Each of the transparent microstructures has at least one inclined angle on its lateral side. The inclined angles, the sides, and the arrangement density of the transparent microstructures can be the same or changed depending on the positions of the transparent microstructures. The shape of the transparent microstructure can be changed for different requirements. By changing the inclined angles, the sides, and the arrangement density of the transparent microstructures, the light brightness and the light uniformity can be enhanced, and the visual perception of light brightness can be increased.

### BACKGROUND OF THE INVENTION

1. Technical Field

The present invention relates to a light source module and, more particularly, to a light source module composed of a light guide plate having on the surface an array of plural transparent microstructures.

2. Description of Related Art

Recently, a light source module has been widely used in the application of televisions, computers, laptop computers and mobile phones, or in indoor/outdoor lighting devices, and, more particularly, the light source module has been generally applied in the light-weighted, thin liquid-crystal display (LCD). An LCD display includes an LCD panel and a light source module, in which the light source module is configured for providing a surface light for the LCD panel. As the demand of LCD displays has greatly increased in recent years, the market trend has been shifting to the development of the goggle-free 3D display. Compared with an LCD display, a goggle-free 3D display requires higher quality in the light source module, especially in the aspect of light brightness, light uniformity, and the visual perception of light brightness.

Depending on the relative position between the light source and the light exiting surface, light source modules can be categorized into two types: edge lighting and bottom lighting. In an edge lighting type of light source module, the light source is disposed at the periphery of the light source module, and the light, once entering the light guide plate, is guided to the light exiting surface through the printed dots or the microstructures on the bottom part of the light guide plate. In a bottom lighting type of light source module, on the other hand, the light source is placed directly on the bottom of the LCD panel in order to enhance light brightness. To collect more light that is projected to the reflective plate by means of total reflection, the light source, after emitting light, first goes through a secondary optical component; the light is then reflected via the reflective plate such that the light can exit uniformly from the front surface. Hence, the bottom lighting type of light source module has higher light-emitting efficiency but at the expense of a thicker module depth.

A light source module includes a light guide plate, a lighting emitting component, and a reflective plate. The light source module transforms the light emitted by the light emitting component into a bright and uniform surface light and provides it for the LCD panel. The light guide plate first transforms the light emitted by the light emitting component into a surface light, and, through the reflective plate on the bottom of the light guide plate, the light emitted from the light guide plate is then reflected back to the inner part of the light guide plate, thereby increasing the efficiency of the light source module.

The primary function of the light guide plate is to increase light brightness uniformity by guiding the direction of light. To achieve the design goals of higher brightness, uniform luminosity, and controllable viewing angle, an approach using a light guide plate with dots and multiple optical films is used to improve light utilization, brightness, and uniformity (referring to U.S. Pat. No. 7,411,732), but this approach adversely introduces the use of optical films. Another approach using a light guide plate with a V-shaped micro-groove cutting structure, although reducing the number of optical films required by controlling the optical intensity through the width and depth of the micro-groove (referring to U.S. Pat. Nos. 7,750,983 and 7,331,758), is more difficult to control light uniformity and fails to improve the visual perception of the light brightness.

### BRIEF SUMMARY OF THE INVENTION

Considering the abovementioned problems, it is an objective of the present invention to enhance the light brightness and light uniformity of a light source module and to increase the visual perception of light brightness. In addition, another objective of the present invention is to reduce the number of optical films for lowering costs.

To achieve the abovementioned objectives, the present invention provides a light source module, which includes a light guide plate, a reflective plate, and at least one light emitting component. The light guide plate includes at least one surface having an array of plural transparent microstructures. Each said transparent microstructure has at least an inclined angle on its lateral side. Depending on the position of the transparent microstructure, the inclined angle and the side of each said transparent microstructure and the arrangement of the transparent microstructures may be changed; i.e., the inclined angle and the side of each said transparent microstructure and the arrangement of the transparent microstructures may be adjusted dynamically for different requirements. The reflective plate is provided underneath the light guide plate, and the light emitting component is adjacent to the light guide plate.

The foregoing light source module can further include an optical adhesive provided between the light emitting component and the light guide plate and provided between the light guide plate and the reflective plate. To reduce light decay, the foregoing light source module can further include an optical coupling component provided between the light emitting component and the light guide plate. In the present invention, the foregoing light source module can further include a transparent optical protection layer or an optical modulation plate, either which is provided on the light guide plate.

In addition, the present invention alternatively provides a light source module, which includes two optical thin films, a light guide plate, a reflective plate, and at least one light emitting component, where the optical thin film is provided on the light guide plate and composed of a diffusion sheet and a brightness enhancement sheet. In the present invention, the foregoing light source module can further include a transparent optical protection layer or an optical modulation plate, either which is provided on the optical thin film. The foregoing light source module can further include a frame for securing the light emitting component, the light guide plate, and other components of the light source module. The frame can further have a reflection function on one side.

Moreover, the present invention alternatively provides a keyboard, which includes a keyboard module and a light source module. The light source module is provided underneath the keyboard module and includes a light guide plate, a reflective plate, and a light emitting component. The light guide plate includes at least one surface having an array of plural transparent microstructures. Each said transparent microstructure is between 4 and 30 μm in height and has at least an inclined angle on its lateral side. The reflective plate is provided underneath the light guide plate. The light emitting component is adjacent to the light guide plate. The keyboard, the reflective plate, and the light guide plate are flexible.

### BRIEF DESCRIPTION OF THE SEVERAL VIEWS OF THE DRAWINGS

The present invention will be best understood by referring to the following detailed description of some illustrative embodiments in conjunction with the accompanying drawings, in which:

FIG. 1 is a schematic view of a light source module according to the first embodiment of the present invention;

FIG. 2 is a schematic view representing a transparent microstructure on the surface of the light guide plate of the light source module according to the first embodiment of the present invention;

FIG. 3 is a schematic view representing an array of transparent microstructures on the surface of the light guide plate of the light source module according to the first embodiment of the present invention;

FIG. 4 is a distribution view representing a perception of light brightness when the present invention is applied to a goggle-free 3D display;

FIG. 5 is a schematic view of a light source module according to the second embodiment of the present invention;

FIG. 6 is a schematic view of a light source module according to the third embodiment of the present invention;

FIG. 7 is a schematic view of a light source module according to the fourth embodiment of the present invention;

FIG. 8 is a schematic view of a light source module according to the fifth embodiment of the present invention;

FIG. 9 is a schematic view of a light source module according to the sixth embodiment of the present invention;

FIG. 10 is a schematic view of a keyboard of the light source module according to the seventh embodiment of the present invention;

FIG. 11 is a schematic view of a keyboard according to the eighth embodiment of the present invention;

FIG. 12 is a schematic view of a keyboard according to the ninth embodiment of the present invention; and

FIGS. 13, 14, and 15 are the schematic views of a keyboard according to the tenth embodiment of the present invention.

### DETAILED DESCRIPTION OF THE INVENTION

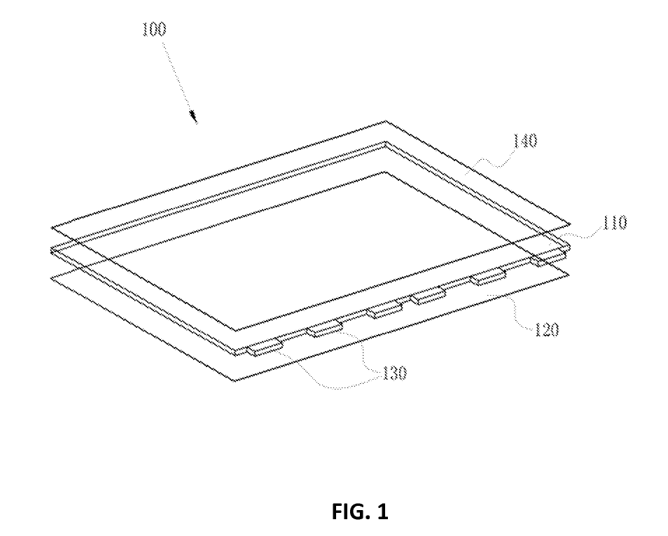

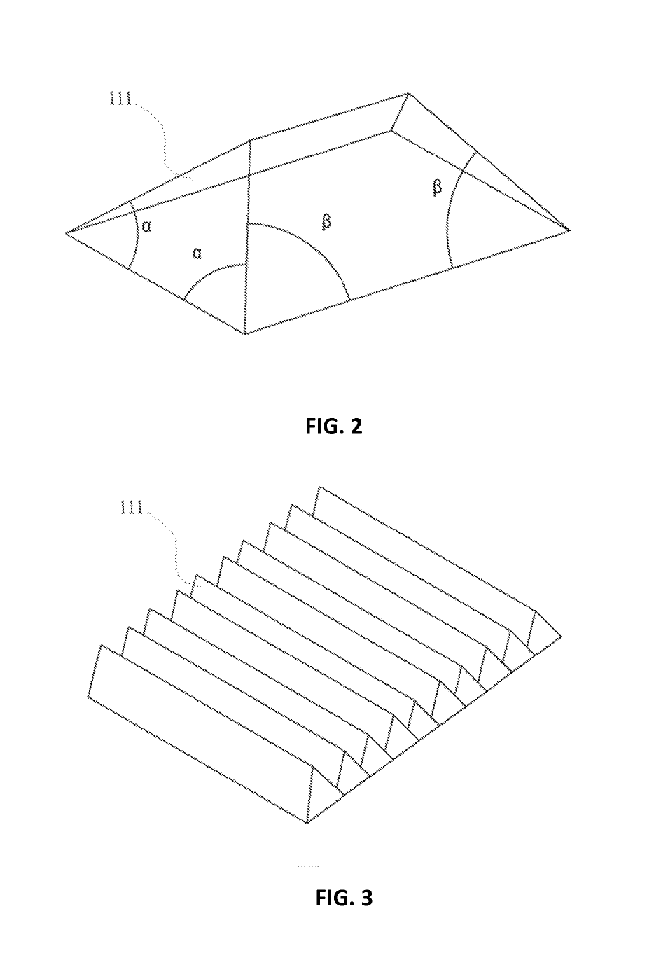

Please refer to FIG. 1 for a schematic view of a light source module according to the first embodiment of the present invention with reference to FIG. 2 for a schematic view representing a transparent microstructure on the surface of the light guide plate of the light source module according to the first embodiment of the present invention and FIG. 3 for a schematic view representing an array of transparent microstructures on the surface of the light guide plate of the light source module according to the first embodiment of the present invention.

As shown in FIGS. 1, 2, and 3, the light source module 100 includes a light guide plate 110, a reflective plate 120, and at least one light emitting component 130.

The light guide plate 110 includes at least one surface having an array of plural transparent microstructures, where each said transparent microstructure has at least one inclined angle α on its lateral side.

The reflective plate 120 is provided underneath the light guide plate 110. As in the edge lighting type of the light source module 100, the reflective plate 120 is used to reflect the light scattered from the bottom part of light guide plate 110 back to the inner part of light guide plate 110 so as to reduce light decay and increase the luminous efficiency of the light source module 100. Moreover, the reflective plate 120 and the light guide plate 110 are flexible.

The light emitting component 130 is adjacent to the light guide plate 110. In the first embodiment of the present invention, the light source is provided through edge lighting; i.e., the light emitting component 130 is provided nearly on one side of the light guide plate 110 and is not overlapped with the light guide plate 110. The number of the light emitting components 130 is adjustable for different conditions.

In the first embodiment of the present invention, the light emitting component 130, as the light source, is adjacent to the light guide plate 110 and projects light to the light guide plate 110 by edge lighting, allowing the light to enter the light guide plate 110 from the lateral side of the light guide plate 110. The light converges toward the light exiting surface of the light guide plate 110 by way of the transparent microstructures 111 on the surface of the light guide plate 110.

The inclined angle α and the side of the transparent microstructure 111 on the surface of the light guide plate 110 and the arrangement density of the transparent microstructures 111 may be changed according to the position of the transparent microstructure 111 on the surface of the light guide plate 110. In addition, the side of the transparent microstructure 111 extends along the tangent direction of the surface of the light guide plate 110; i.e., the extending direction of the side of the transparent microstructure 111 is perpendicular to the normal direction of the surface of the light guide plate 110. The side of each of the transparent microstructures 111 may be different in length or the same in shape for different requirements. In other words, depending on the position disposed on the light guide plate 110, each of the transparent microstructures 111 may have different inclined angle α, side length, and the arrangement density of transparent microstructures may also be different. Alternatively, each of the transparent microstructures may have the same inclined angle α and side length.

The inclined angles and the sides of the transparent microstructures and the arrangement density relating to the transparent microstructures described in the embodiments of the present invention may be adjusted dynamically according to the requirements for light brightness and uniformity of the light source module 100. In more detail, each inclined angle α of the transparent microstructures may be changed to enhance light brightness. Likewise, the light uniformity can be increased by changing the side of each of the transparent microstructures and the arrangement density of the transparent microstructures.

Depending on different requirements for light brightness, all inclined angles α of each of the transparent microstructures may be separately adjusted. In other words, each inclined angle of each transparent microstructure may have different value. For example, the transparent microstructure 111 may have on one side at least two different inclined angles or have the same inclined angles. In more detail, each inclined angle on one side of the transparent microstructure can be separately changed such that the inclined angles on one side can be α and β or at least two different values or the same angle of α, thereby enhancing light brightness.

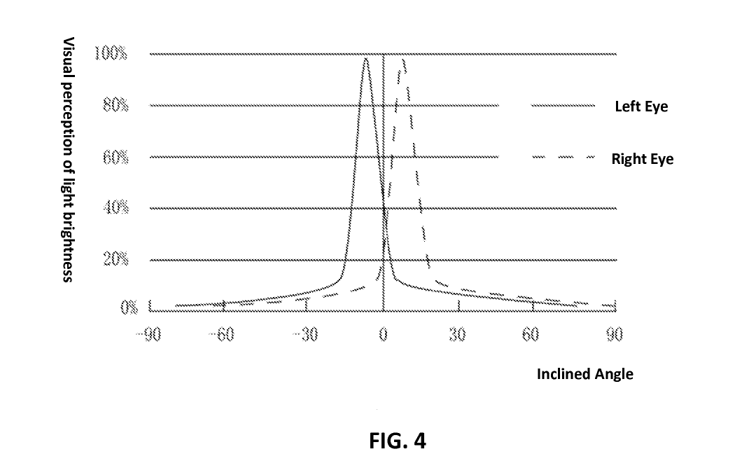

Referring to FIG. 4, each of the two opposite lateral sides of the transparent microstructure has at least one inclined angle α. Hence, the light exiting from the surface of the light guide plate 110 does not project toward all angles uniformly nor project along the normal direction of the surface of the light guide plate 110; instead, the light first converges on two angles and then diverges before projecting outward. When a viewer observes the light source module 100 from the front side, the light, after being diverged from the two angles, provides the viewer's left eye and right eye a visual perception of greatest light brightness respectively.

When the present invention is applied to a goggle-free 3D display, the viewer's left eye and right eye separately receive the image from two different angles, and the light emitting from the light source module 100 is received by the viewer's left eye and right eye respectively, thereby increasing the viewer's perception of light. In addition, the 3D visual effect is enhanced because the viewer's left eye and right eye separately receive the image from two different angles.

It is worth noting that in the first embodiment of the present invention, the light source module can further include an optical adhesive (not shown). The optical adhesive is separately provided between the light emitting component 130 and the light guide plate 110 and provided between the light guide plate 110 and the reflective plate 120. The optical adhesive is used to secure the components of the light source module and thus increases the optical efficiency of the light source module.

As shown in FIG. 1, the light source module 100 of the first embodiment further includes a transparent optical protection layer 140 provided on the light guide plate 110. The optical protection layer 140 is used to protect the light guide plate 110 and modulate the optical properties of the light source module.

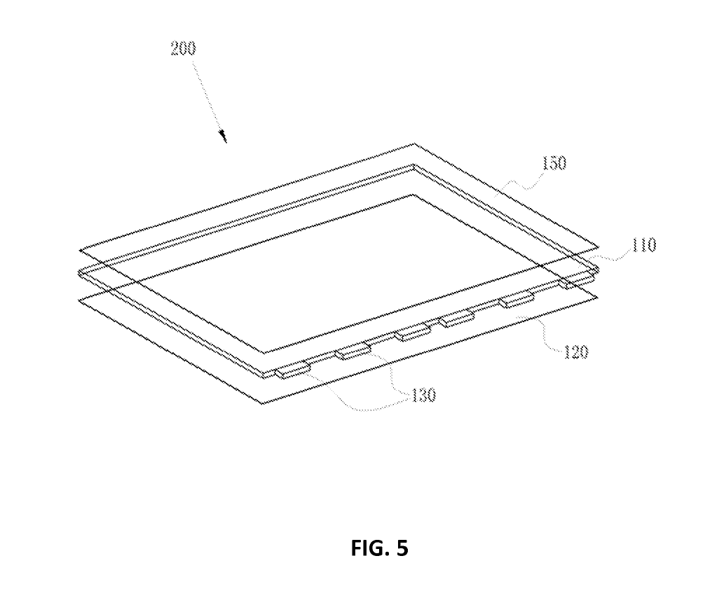

Referring to FIG. 5 for the light source module of the second embodiment of the present invention, the light source module 200 is substantially similar to the light source module 100 of the first embodiment. In the description that follows, components that are the same or similar in the two embodiments maintain same notations and only differences between the two embodiments are described.

The light source module 200 of the second embodiment further includes an optical modulation plate 150 provided on the light guide plate 110. The optical modulation plate 150 is used to modulate the optical properties of the light source module 200.

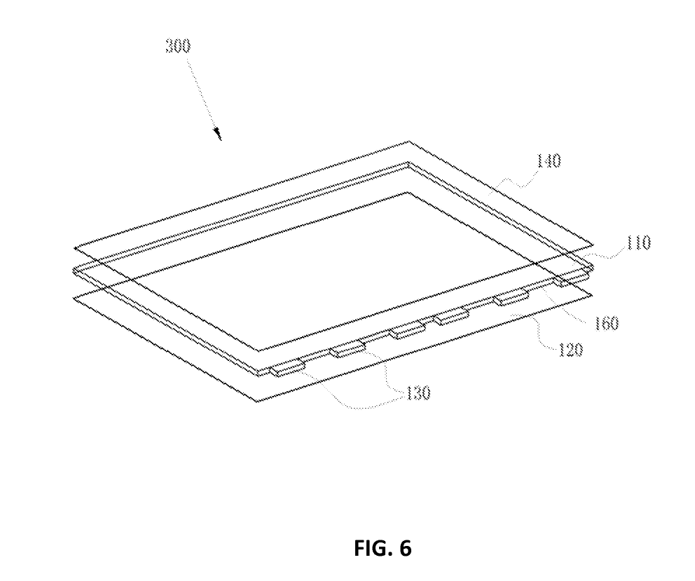

Referring to FIG. 6 for the light source module of the third embodiment of the present invention, the light source module 300 is substantially similar to the light source module 100 of the first embodiment. In the description that follows, components that are the same or similar in the two embodiments maintain same notations and only differences between the two embodiments are described. The light source module 300 of the third embodiment further includes an optical coupling component 160. The optical coupling component 160 is provided between the light guide plate 110 and at least one light emitting component 130 such that the light emitted by the light emitting component 130 can converge more properly through the optical coupling component 160, allowing a higher percentage of light to enter the light guide plate 110.

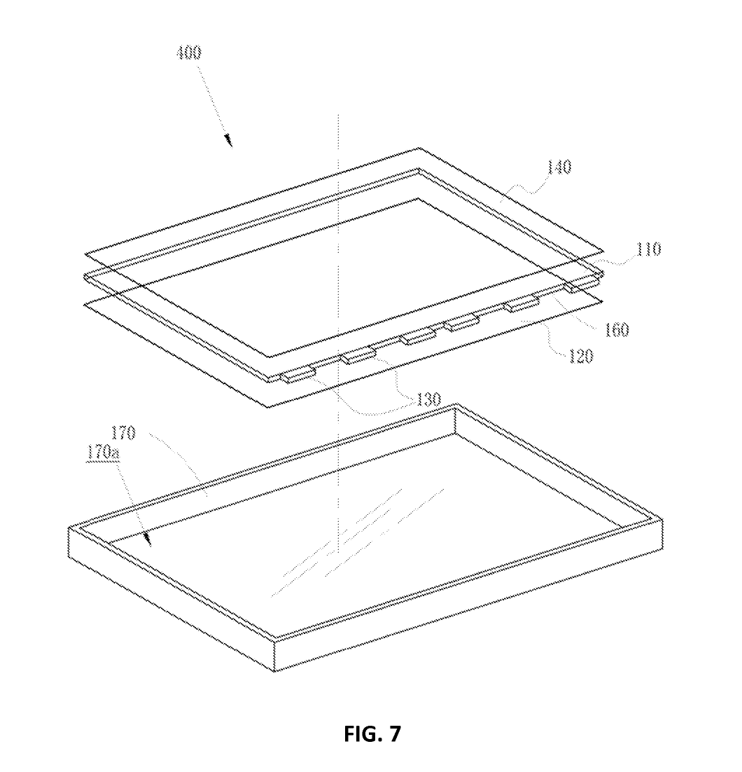

Referring to FIG. 7 for the light source module of the fourth embodiment of the present invention, the light source module 400 is substantially similar to the light source module 100 of the first embodiment. In the description that follows, components that are the same or similar in the two embodiments maintain same notations and only differences between the two embodiments are described. The light source module 400 of the fourth embodiment of the present invention includes a light guide plate 110, a reflective plate 120, at least one light emitting component 130, and a frame 170. The frame 170 can be properly configured for securing the light emitting component 130, the light guide plate 110, the reflective plate 120, and other components of the light source module. Moreover, the reflective function of the reflective plate 120 can be incorporated into the upper surface 170a of the frame 170 so that the number of optical components of the light source module can be reduced and thus so can the module depth.

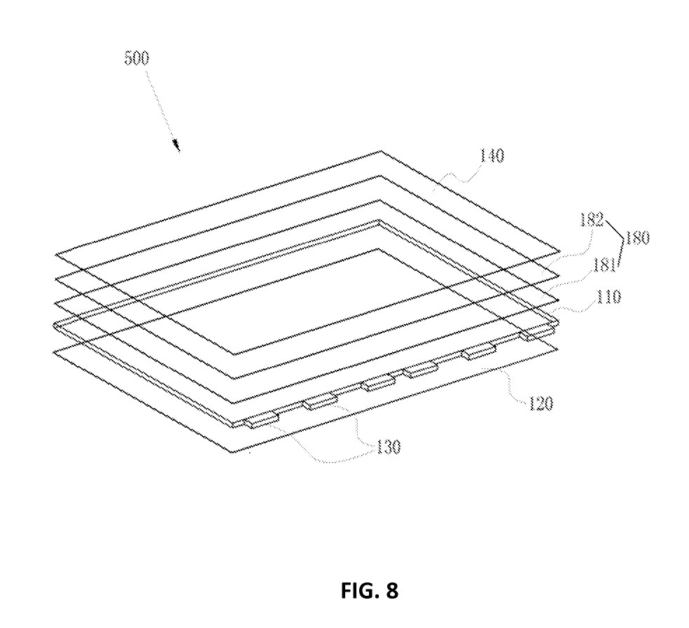

Referring to FIG. 8 for the light source module of the fifth embodiment of the present invention, components that are the same or similar in the embodiment and previous embodiment maintain same notations and only differences between the two embodiments are described.

The light source module 500 of the embodiment of the present invention includes at least one optical thin film 180, a light guide plate 110, a reflective plate 120, and at least one light emitting component 130. The optical thin film 180 is provided on the light guide plate 110 and composed of a diffusion sheet 181 and a brightness enhancement sheet 182. The diffusion sheet 181 is used to create optical diffusion through refraction, reflection, and scattering of light, allowing the light source module 500 to increase light uniformity. The brightness enhancement sheet 182 is used to converge light through refraction and reflection of light, allowing the light source module 500 to enhance brightness. The use of the diffusion sheet 181 and the brightness enhancement sheet 182 depends on practical requirements and should not be limited by the embodiments set forth herein. In the fifth embodiment of the present invention, the light guide plate 110, the reflective plate 120, and the light emitting component 130 are the same as disclosed in the first embodiment of the present invention and thus no detailed description is repeated herein.

The light source module 500 further includes a transparent optical protection layer 140 provided on the optical thin film 180. The optical protection layer 140 is used to protect the optical thin film 180 and the light guide plate 110 and, furthermore, to modulate the optical properties of the light source module 500.

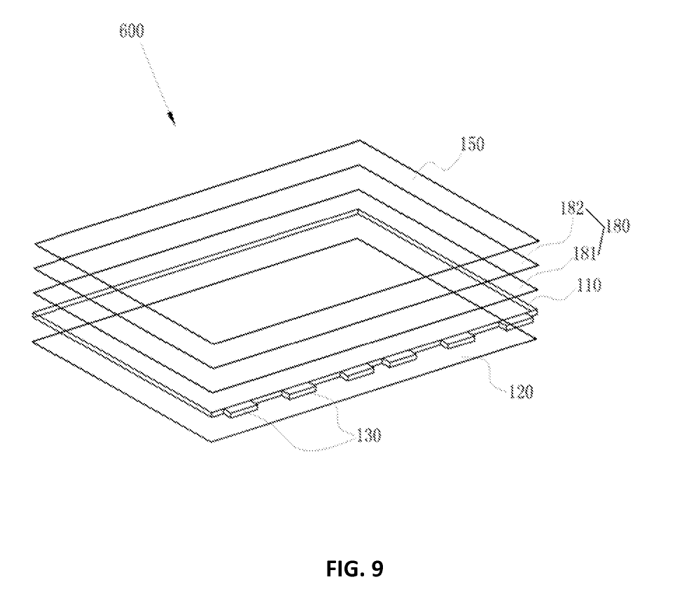

Referring to FIG. 9 for the light source module 600 of the sixth embodiment of the present invention, other than an optical modulation plate 150, the components, including the optical thin film 180, the light guide plate 110, the reflective plate 120, and the light emitting component 130, are the same as disclosed in the fifth embodiment of the present invention. The optical modulation plate 150, just like the optical protection layer, is provided on the optical thin film 180 and is used to modulate the optical properties of the light source module 600.

The light source module 500 of the fifth embodiment and the light source module 600 of the sixth embodiment each further includes an optical coupling component 160 provided between the light guide plate 110 and at least one light emitting component 130. The light emitted by the light emitting component 130 can converge more properly through the optical coupling component 160, allowing a higher percentage of light to enter the light guide plate 110.

The light source module 500 of the fifth embodiment and the light source module 600 of the sixth embodiment each further includes a frame 170. The frame 170 can be properly configured for securing the light emitting component 130, the light guide plate 110, the reflective plate 120, and other components of the light source module. Moreover, the reflective function of the reflective plate 120 can be incorporated into the upper surface 170a of the frame 170 so that the number of optical components of the light source module is reduced and thus so is the module depth.

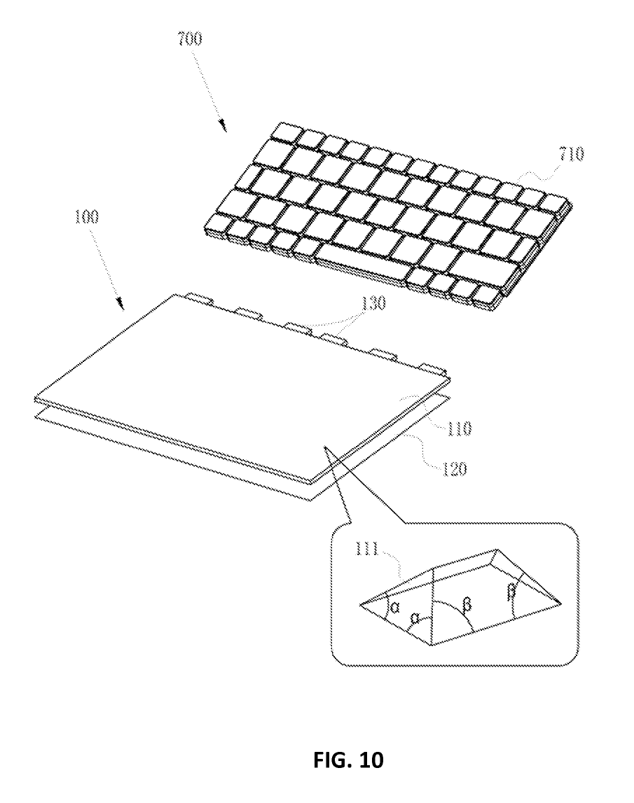

Please refer to FIG. 10 for a schematic view of a keyboard of the light source module according to the seventh embodiment of the present invention and FIG. 1 for a schematic view of a light source module according to the first embodiment of the present invention, with reference to FIG. 2 for a schematic view representing a transparent microstructure on the surface of the light guide plate of the light source module according to the first embodiment of the present invention and FIG. 3 for a schematic view representing an array of transparent microstructures on the surface of the light guide plate of the light source module according to the first embodiment of the present invention.

The seventh embodiment includes a keyboard module 710, a light source module 100, and a case (not shown). The light source module 100 is provided underneath the keyboard module 710. The case is used to secure the keyboard module 710 and the light source module 100. The light source module 100 includes a light guide plate 110, a reflective plate 120, and at least one light emitting component 130.

The light guide plate 110 includes at least one surface having an array of plural transparent microstructures. Each of the transparent microstructures is between 4 and 30 μm in height and has at least one inclined angle on its lateral side. The reflective plate 120 is provided underneath the light guide plate 110 and can be provided at different position according to the lighting type of the light source module. In the seventh embodiment of the present invention, the light source is disposed based on the edge lighting type. In an edge lighting type of light source module, the reflective plate 120 is used to reflect the light scattered from the bottom of the light guide plate 110 back to the inner part of the light guide plate 110 so as to reduce light decay and thus increase efficiency of the light source module. Moreover, the reflective plate 120 and the light guide plate 110 are flexible. The light emitting component 130 is adjacent to the light guide plate 110 and provides light through edge lighting; i.e., the light emitting component 130 is provided nearly on one side of the light guide plate 110, and the number of the light emitting components 130 is adjustable for different conditions. It is worth noting that the keyboard module 710, the light guide plate 110, and the reflective plate 120 are flexible. The light source module in the seventh embodiment is the same as disclosed in the first embodiment and thus no detailed description is repeated herein.

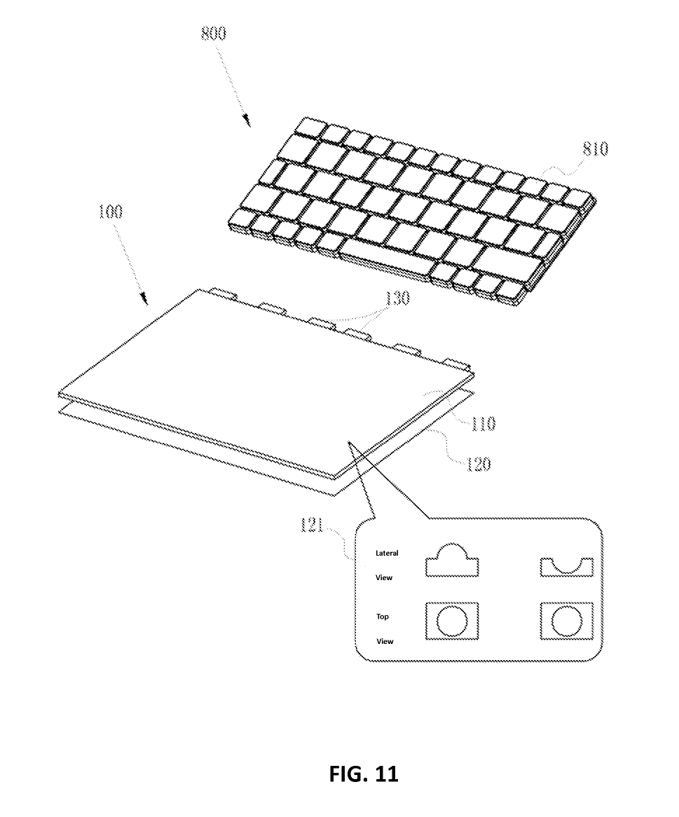

Referring to FIG. 11, a keyboard 800 disclosed in the eighth embodiment of the present invention includes a keyboard module 810, a light source module 100, and a case (not shown). The light source module 100 is provided underneath the keyboard module 810. The case is used to secure the keyboard module 810 and the light source module 100. The light source module 100 includes a light guide plate 110, a reflective plate 120, and at least one light emitting component 130. The keyboard module 810, the light guide plate 110, and the reflective plate 120 are flexible.

The keyboard 800 of the eighth embodiment differs from the seventh embodiment in that the cross-section of the transparent microstructure 121 in the eighth embodiment is round, where the transparent microstructure 121 can be a structure of convex hemisphere or concave hemisphere with solid angle of 2π or a structure of convex spherical cap or concave spherical cap with solid angle less than 2π. The transparent microstructures may cause errors in shape during manufacturing.

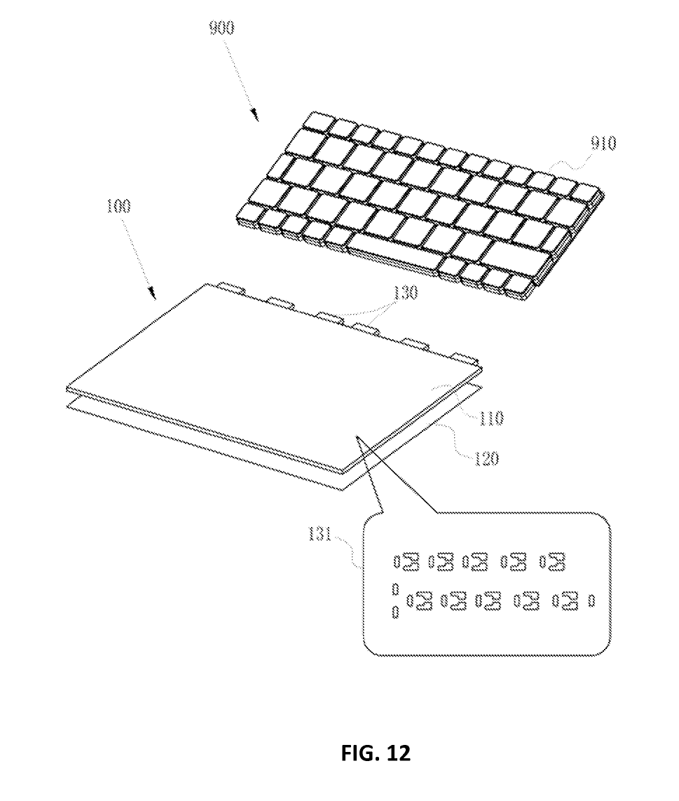

Referring to FIG. 12, a keyboard 900 disclosed in the ninth embodiment of the present invention includes a keyboard module 910, a light source module 100, and a case (not shown). The light source module 100 is provided underneath the keyboard module 910. The case is used to secure the keyboard module 910 and the light source module 100. The light source module 100 includes a light guide plate 110, a reflective plate 120, and at least one light emitting component 130. The keyboard module 910, the light guide plate 110, and the reflective plate 120 are flexible.

The keyboard 900 of the ninth embodiment differs from the keyboard of the seventh embodiment in that the light guide plate 110 of the ninth embodiment is provided with plural non-microstructural cutting holes 131. The cutting holes 131 cause reflection of light on the light guide plate 110, allowing the adjustment of light distribution. Likewise, the sides of the cutting holes and the arrangement density of the cutting holes 131 can be adjusted to increase light uniformity.

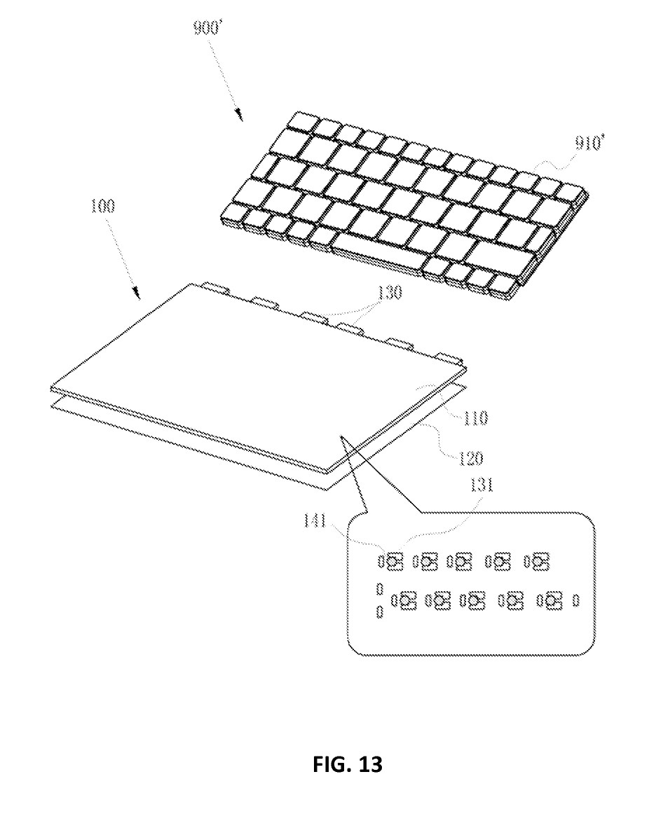

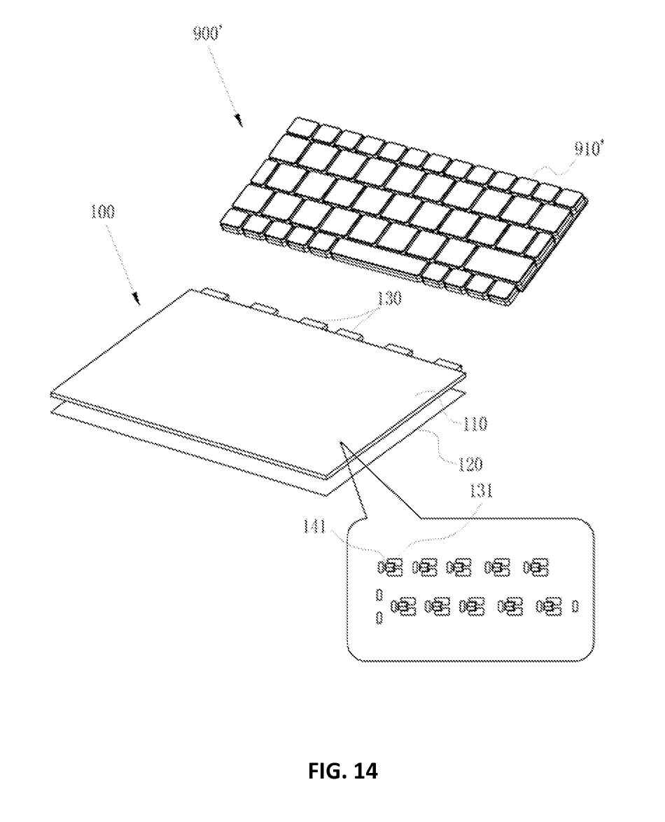

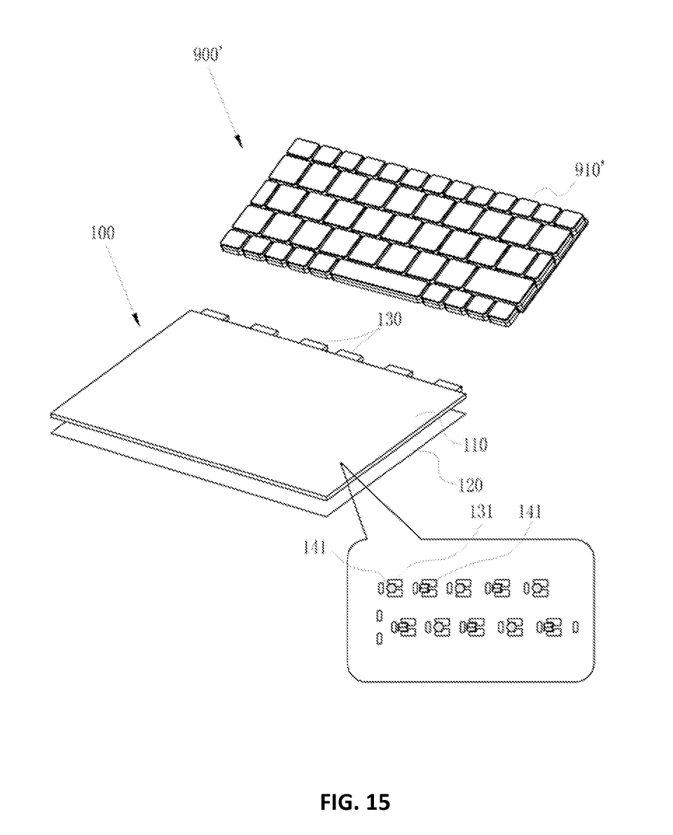

Referring to FIGS. 13, 14, and 15, a keyboard 900′ disclosed in the tenth embodiment of the present invention includes a keyboard module 910′, a light source module 100, and a case (not shown). The light source module 100 is provided underneath the keyboard module 910′. The case is used to secure the keyboard module 910′ and the light source module 100. The light source module 100 includes a light guide plate 100, a reflective plate 120, and at least one light emitting component 130. The keyboard module 910′, the light guide plate 110, and the reflective plate 120 are flexible.

The keyboard 900′ of the tenth embodiment differs from the eighth and the ninth embodiments in that the light guide plate 110 of the tenth embodiment is provided with transparent microstructures 141 and plural of non-microstructural cutting holes 131. The transparent microstructure 141 can be a microstructure having an inclined angle on its lateral side (as in the transparent microstructure 111), a microstructure having round cross-section (as in the transparent microstructure 121) shape, or a microstructure with other shape. The light uniformity can be increased by changing the arrangement of each transparent microstructure 141 or each cutting hole 131 in the array.

What is claimed is:

1. A light source module, comprising:
a light guide plate comprising at least a characteristic surface, the characteristic surface having an array of a plurality of transparent microstructures, each said transparent microstructure having on a lateral side at least an inclined angle;
a reflective plate provided underneath the light guide plate; and
at least a light emitting component adjacent to the light guide plate.

2. The light source module of claim 1, wherein each of said transparent microstructures has the same inclined angle.

3. The light source module of claim 1, wherein each said transparent microstructure has on the lateral side at least two different inclined angles.

4. The light source module of claim 1, wherein at least one item from the inclined angle, the side of each said transparent microstructure, and the arrangement density of the transparent microstructures can be changed according to the position of the transparent microstructure.

5. The light source module of claim 1, further comprising an optical adhesive, wherein the optical adhesive is separately provided between the light emitting component and the light guide plate and between the light guide plate and the reflective plate, the optical adhesive being used to facilitate the optical efficiency of the light source module.

6. The light source module of claim 1, further comprising an optical coupling component, wherein the optical coupling component is provided between the light emitting component and the light guide plate.

7. The light source module of claim 1, further comprising an optical thin film provided above the light guide plate, wherein the optical thin film is used to adjust the scattering and brightness properties of light.

8. The light source module of claim 1, further comprising a transparent optical protection layer, wherein the optical protection layer is provided on the light guide plate or the optical thin film.

9. The light source module of claim 6, further comprising a transparent optical protection layer, wherein the optical protection layer is provided on the light guide plate or the optical thin film.

10. The light source module of claim 7, further comprising a transparent optical protection layer, wherein the optical protection layer is provided on the light guide plate or the optical thin film.

11. The light source module of claim 1, further comprising an optical modulation plate, wherein the optical modulation plate, provided on the light guide plate or the optical thin film, is used to modulate the optical properties of the light source module.

12. The light source module of claim 6, further comprising an optical modulation plate, wherein the optical modulation plate, provided on the light guide plate or the optical thin film, is used to modulate the optical properties of the light source module.

13. The light source module of claim 7, further comprising an optical modulation plate, wherein the optical modulation plate, provided on the light guide plate or the optical thin film, is used to modulate the optical properties of the light source module.

14. The light source module of claim 1, further comprising a frame, wherein the frame is used to secure the light emitting component, the light guiding component, and other components of the light source module.

15. The light source module of claim 6, further comprising a frame, wherein the frame is used to secure the light emitting component, the light guiding component, and other components of the light source module.

16. The light source module of claim 7, further comprising a frame, wherein the frame is used to secure the light emitting component, the light guiding component, and other components of the light source module.

17. The light source module of claim 14, wherein the light source module has no the reflective plate, and the frame has on a side a reflection function.

18. The light source module of claim 15, wherein the light source module has no the reflective plate, and the frame has on a side a reflection function.

19. The light source module of claim 16, wherein the light source module has no the reflective plate, and the frame has on a side a reflection function.

20. The light source module of claim 1, wherein the light guide plate and the reflective plate are flexible.

21. A keyboard, comprising:
a keyboard module;
a light source module provided underneath the keyboard module, the light source module comprising:
a light guide plate comprising at least a surface, the surface having an array of a plurality of transparent microstructures, each said transparent microstructure being between 4 and 30 μm in height;
a reflective plate provided underneath the light guide plate; and
at least a light emitting component adjacent to the light guide plate.

22. The keyboard of claim 21, wherein each said transparent microstructure has on a lateral side at least an inclined angle.

23. The keyboard of claim 21, wherein the cross-section of each said transparent microstructure is round.

24. A keyboard, comprising:
a keyboard module;
a light source module provided underneath the keyboard module, the light source module comprising:
a light guide plate having a plurality of non-microstructural cutting holes;
a reflective plate provided underneath the light guide plate; and
at least a light emitting component adjacent to the light guide plate.

25. The keyboard of claim 24, the light guide plate further comprising an array of a plurality of transparent microstructures.

26. The keyboard of claim 24, wherein the keyboard module, the light guide plate, and the reflective plate are flexible.

27. The keyboard of claim 25, wherein the keyboard module, the light guide plate, and the reflective plate are flexible.
